(19) United States
(12) Patent Application Publication
(10) Pub. No.: US 2007/0281843 A1
(43) Pub. Date: Dec. 6, 2007

(54) Roll Sleeve

(75) Inventor: Uwe Matuschczyk, Geislingen (DE)

Correspondence Address: GREENBLUM & BERNSTEIN, P.L.C., 1950 ROLAND CLARKE PLACE, RESTON, VA, 20191, US

(73) Assignee: VOITH PATENT GMBH, Heidenheim (DE)

(21) Appl. No.: 11/571,875

(22) PCT Filed: Jun. 3, 2005
(86) PCT No.: PCT/EP05/52550

§ 371 Date: Jan. 9, 2007

(30) Foreign Application Priority Data
Jul. 13, 2004 (DE) 10 2004 033 751.9

(51) Int. Cl. F26B 13/04

(52) U.S. Cl. 492/48

(57) ABSTRACT

The invention relates to a flexible roll sleeve (3) of a press roll used for processing a paper web, cardboard web, tissue web, or another fiber web (1) in a machine for producing and/or refining the same. Said flexible roll sleeve (3) comprises interior supporting elements (5) composed of at least two circumferential layers. In order to increase the service life especially of large press rolls, the layer (7) located on the inside in a radial direction is harder than the layer (8) located on the outside.

The invention relates to a flexible roll sleeve of a press roll for treating a paper, cardboard, tissue or another fibrous web in a machine for manufacturing and/or finishing the latter, having support elements which lie on the inside and comprise at least two circumferential layers.

In press rolls of this type, the roll sleeve is pressed by the support elements in the direction of a backing roll with the formation of a pressure nip. In particular at press pressures of more than 15 MPa, damage often occurs to the roll sleeve during contact with the support elements.

Here, the flexibility of the roll sleeve makes it necessary to form prolonged pressure nips. For this purpose, the support elements have concave press faces which press the roll sleeve with respect to the cylindrical backing roll.

It is therefore the object of the invention to extend the service life of the roll sleeve while ensuring sufficient flexibility of the latter, in particular at high press pressures.

According to the invention, the object is achieved in that the inner layer which lies radially on the inside is harder than the outer layer which lies on the outside.

While the softer outer layer ensures sufficient flexibility and adaptation to the contour of the backing roll, the inner layer is protected from damage during contact with the support elements on account of the greater hardness, even at high press pressures of more than 15 MPa. As a consequence, the service life of the roll sleeve is extended considerably.

Here, the hardness of the inner layer should lie between 40 and 80, preferably between 50 and 60 Shore D, and the hardness of the outer layer should lie between 70 and 95 Shore A.

The thickness of the inner layer should be at most 4 mm and preferably lie between 3 and 3.7 mm.

The thickness of the outer layer should preferably lie between 2 and 3 mm. In press rolls for smoothing the fibrous web, the thickness of the outer layer is determined independently of the preferred range of the wear to be expected.

Press rolls for dewatering the fibrous web often have blind bores and/or grooves which lie on the outside, in order to receive the water which is pressed out. The thickness of the outer layer should therefore be greater in every case than the depth of the blind bores or grooves.

For a balanced ratio between the hardness of the inner layer and the flexibility of the roll sleeve, it is advantageous if the inner layer is thicker than the outer layer or if the thickness of the inner layer corresponds approximately to the thickness of the outer layer.

With regard to the design and manufacture, it is also of advantage if at least the inner layer and preferably also the outer layer consist of a plastic.

Polyurethane, in particular, is suitable for this purpose.

It is possible here that the two layers are cast simultaneously as far as possible via different feeder heads. However, it can also be advantageous if the second layer is effected only after curing of the first layer and possibly the addition of an adhesion promoter between the layers.

In order to improve the strength of the inner layer and therefore of the overall roll sleeve, the inner layer should enclose reinforcing elements, preferably in the form of a woven fabric and/or laid scrim. Sufficient strength with simultaneously acceptable limitation of the homogeneity of the inner layer results if the proportion of the reinforcing elements in the volume of the inner layer lies between 5 and 30%.

The outer layer should preferably not have any reinforcing elements, in order to ensure sufficient flexibility of the roll sleeve.

Moreover it is of advantage if the modulus of elasticity of the inner layer is greater than that of the outer layer. As small a difference as possible in the modulus of elasticity between the plastic of the inner layer and the reinforcing elements reduces the shear forces at the interfaces between them and thus extends the service life.

If the press roll is used for smoothing the fibrous web, it is of advantage if the hardness of the outer layer lies between 85 and 90 Shore A. Moreover, the roughness of the surface of the outer layer should be less than 2 micrometers.

If the backing roll is heated, which is often the case, in particular, during smoothing of the fibrous web, damage to the roll sleeve as a consequence of contact with the hot backing roll can be prevented by the fact that the external diameter of the outer layer becomes smaller at the edge of the press roll outside the contact region with the fibrous web.

If the press roll is used for dewatering the fibrous web, it is advantageous if the hardness of the outer layer lies between 90 and 95 Shore A.

In the following text, the invention is to be explained in greater detail using a plurality of exemplary embodiments. In the appended drawing:

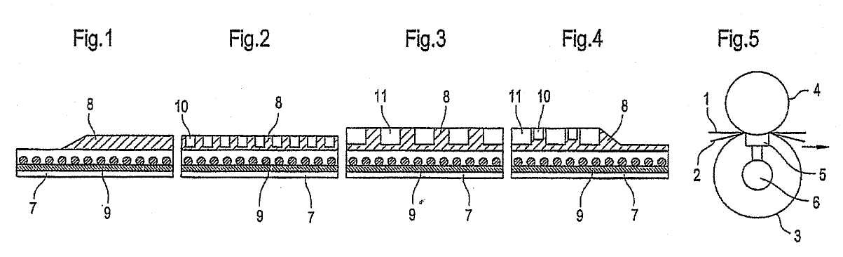

FIG. 1 shows a roll sleeve 3 for smoothing,

FIGS. 2-4 show a roll sleeve 3 for dewatering, and

FIG. 5 shows a press arrangement.

According to FIG. 5, the fibrous web 1 is guided, together with a dewatering belt 2 for receiving the water which is pressed out, through the pressure nip which is formed by a press roll and a cylindrical backing roll 4. In this dewatering apparatus of a paper machine, the pressure nip is of extended configuration in the interests of intensive but gentle dewatering. For this purpose, the flexible roll sleeve 3 of the press roll runs over a support element 5 having a concave pressing face.

The support element 5 is supported on the carrier 6 of the press roll and presses the roll sleeve 3 toward the backing roll 4.

The support element 5 is lubricated hydrostatically and has oil pressure pockets. In order, above all at press pressures of more than 10 MPa, in particular more than 20 MPa, to prevent that, during passage of a lump of fibrous web residues and/or contaminants through the pressure nip, the roll sleeve 3 is pressed into the oil pressure pockets of the support element 5 and is damaged, the roll sleeve 3 has a special construction.

As can be seen in FIGS. 1 to 4, the roll sleeve 3 comprises two circumferential layers made from polyurethane, an inner layer 7 which lies radially on the inside and an outer outer layer 8. In order to prevent damage to the inner layer 7, in particular in the abovementioned cases, and thus to extend the service life of the roll sleeve 3, the inner layer 7 is configured to be harder than the outer layer 8.

In order that the roll sleeve 3 obtains a sufficient strength, the inner layer 7 encloses reinforcing elements 9 in the form of a laid scrim comprising threads which extend in the circumferential direction and transversely with respect thereto. The volume of the threads is approximately 20 to 30% of the volume of the inner layer 7.

Here, the inner layer 7 has a hardness between 50 and 60 Shore D and a thickness between 3 and 3.7 mm.

The thickness of the outer layer 8 lies between 2 and 3 mm, the inner layer 7 being thicker than the outer layer 8.

The roll sleeve 3 which is shown in FIG. 1 is used in press rolls for smoothing the fibrous web 1, for which reason the roughness of the surface which comes into contact with the fibrous web 1 is less than 2 micrometers. As, during smoothing in general, the fibrous web 1 is guided alone through the pressure nip and the backing roll 4 is heated, the roll sleeve 3 has to be protected against direct contact with the backing roll 4. The external diameter of the outer layer 8 is therefore reduced at the edge of the press roll outside the contact region with the fibrous web 1. As can be seen, this can take place to the extent that the outer layer 8 disappears completely toward the end of the press roll.

Here, the hardness of the outer layer 8 lies between 85 and 90 Shore A.

The press sleeves 3 which are shown in FIGS. 2 to 4 are used in press rolls for dewatering the fibrous web 1.

In order to receive the water which is pressed out of the fibrous web 1 and passes through the dewatering belt 2 to the roll sleeve 3, said roll sleeves 3 have blind bores 11 on the outside and grooves 10 which extend in the circumferential direction.

The depth of said blind bores 11 and grooves 10 is less than the thickness of the outer layer 8, in order not to weaken the inner layer 7. The hardness of the outer layer lies between 90 and 95 Shore A.

In all cases, the modulus of elasticity of the inner layer 7 is higher than that of the outer layer 8.

1-17. (canceled)

18. A flexible roll sleeve (3) of a press roll for treating a paper, cardboard, tissue or another fibrous web (1) in a machine for manufacturing and/or finishing the latter, having support elements (5) which lie on the inside, comprising at least two circumferential layers, the inner layer (7) which lies radially on the inside being harder than the outer layer (8) which lies on the outside, characterized in that the inner layer (7) is thicker than the outer layer (8) and the inner layer encloses reinforcing elements (9).

19. The flexible roll sleeve (3) as claimed in claim 18, characterized in that the hardness of the inner layer (7) lies between 40 and 80, preferably between 50 and 60 Shore D.

20. The flexible roll sleeve (3) as claimed in claim 18, characterized in that the hardness of the outer layer (8) lies between 70 and 95 Shore A.

21. The flexible roll sleeve (3) as claimed in claim 18, characterized in that the thickness of the inner layer (7) is at most 4 mm and preferably lies between 3 and 3.7 mm.

22. The flexible roll sleeve (3) as claimed in claim 18, characterized in that the thickness of the outer layer (8) lies between 2 and 3 mm.

23. The flexible roll sleeve (3) as claimed in claim 18, characterized in that at least the inner layer (7) and preferably also the outer layer (8) consist of a plastic.

24. The flexible roll sleeve (3) as claimed in claim 18, characterized in that the proportion of the reinforcing elements (9) in the volume of the inner layer (7) lies between 5 and 30%.

25. The flexible roll sleeve (3) as claimed in claim 18, characterized in that the outer layer (8) does not have any reinforcing elements (9).

26. The flexible roll sleeve (3) as claimed in claim 18, characterized in that the modulus of elasticity of the inner layer (7) is greater than that of the outer layer (8).

27. The flexible roll sleeve (3) of a press roll for smoothing the fibrous web (1) as claimed in claim 18, characterized in that the hardness of the outer layer (8) lies between 85 and 90 Shore A.

28. The flexible roll sleeve (3) of a press roll for smoothing the fibrous web (1) as claimed in claim 18, characterized in that the roughness of the surface of the outer layer (8) is less than 2 micrometers.

29. The flexible roll sleeve (3) of a press roll for smoothing the fibrous web (1) as claimed in claim 18, characterized in that the external diameter of the outer layer (8) is reduced at the edge of the press roll outside the contact region with the fibrous web (1).

30. The flexible roll sleeve (3) of a press roll for dewatering the fibrous web (1) as claimed in claim 18, characterized in that the hardness of the outer layer (8) lies between 90 and 95 Shore A.

31. The flexible roll sleeve (3) of a press roll for dewatering the fibrous web (1) having blind bores (11) and/or grooves (10) which lie on the outside, as claimed in claim 18, characterized in that the thickness of the outer layer (8) is greater than the depth of the blind bores (11) or grooves (10).
